(19) United States
(12) Patent Application Publication
(10) Pub. No.: US 2025/0153665 A1
(43) Pub. Date: May 15, 2025

(54) ROUTING STRUCTURE

(71) Applicant: YAZAKI CORPORATION, Tokyo (JP)

(72) Inventors: Kosuke Tomosada, Makinohara-shi (JP); Naoto Kogure, Makinohara-shi (JP)

(21) Appl. No.: 18/940,727

(22) Filed: Nov. 7, 2024

(30) Foreign Application Priority Data
Nov. 13, 2023 (JP) 2023-192665

(51) Int. Cl. B60R 16/027; B60J 7/04; B60R 16/02

(52) U.S. Cl. CPC B60R 16/027; B60J 7/04; B60R 16/0207

(57) ABSTRACT

A routing structure includes: a first fixing part fixed to a vehicle body of a vehicle; a second fixing part fixed to a slide body that moves along a vehicle front-rear direction; an exterior member having a first end portion held by the first fixing part and a second end portion held by the second fixing part; an electric wire inserted through the exterior member; and a biasing member inserted through the exterior member and forming a curved portion curved in the vehicle front-rear direction between the first end portion and the second end portion of the exterior member.

### CROSS-REFERENCE TO RELATED APPLICATION(S)

The present application claims priority to and incorporates by reference the entire contents of Japanese Patent Application No. 2023-192665 filed in Japan on Nov. 13, 2023.

### BACKGROUND OF THE INVENTION

### 1. Field of the Invention

The present invention relates to a routing structure.

### 2. Description of the Related Art

Conventionally, there is a power feeding device for a slide body. Japanese Patent Application Laid-open No. 2011-151906 discloses a power feeding device for a slide body including a wire harness routed over a vehicle body and a slide body that is slidably provided on the vehicle body and opens and closes an opening formed in the vehicle body.

It has been studied by the inventor of the present application to arrange a biasing member having rigidity inside an exterior member when the exterior member is included in a routing structure between a vehicle body and a slide body. Here, in a case where the biasing member is curved in a narrow space between the vehicle body and the slide body, the biasing member is likely to have a tapered shape in the curved portion. The tapered shape of the curved portion causes a decrease in bending radius of an electric wire.

### SUMMARY OF THE INVENTION

An object of the present invention is to provide a routing structure capable of suppressing a biasing member from having a tapered shape.

A routing structure according to one aspect of the invention includes a first fixing part fixed to a vehicle body of a vehicle; a second fixing part fixed to a slide body that moves along a vehicle front-rear direction with respect to an opening provided in a roof of the vehicle body; an exterior member having a first end portion held by the first fixing part and a second end portion held by the second fixing part; an electric wire inserted through the exterior member; and a biasing member inserted through the exterior member and forming a curved portion curved in the vehicle front-rear direction between the first end portion and the second end portion of the exterior member, wherein the second fixing part is disposed above the first fixing part in a vehicle up-down direction, and the first fixing part and the second fixing part hold the first end portion and the second end portion such that the curved portion is inclined with respect to the vehicle up-down direction when viewed from the vehicle front-rear direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a side view of the routing structure according to the embodiment;

FIG. 4 is a view for explaining a tapered shape;

FIG. 5 is a cross-sectional view of the routing structure according to the embodiment; and

FIG. 6 is a cross-sectional view of the routing structure according to the embodiment.

### DETAILED DESCRIPTION OF THE PREFERRED EMBODIMENTS

Hereinafter, a routing structure according to an embodiment of the present invention will be described in detail with reference to the drawings. Note that the present invention is not limited by the present embodiment. In addition, the components in the following embodiment include those that can be easily imagined by those skilled in the art or those that are substantially the same.

### Embodiment

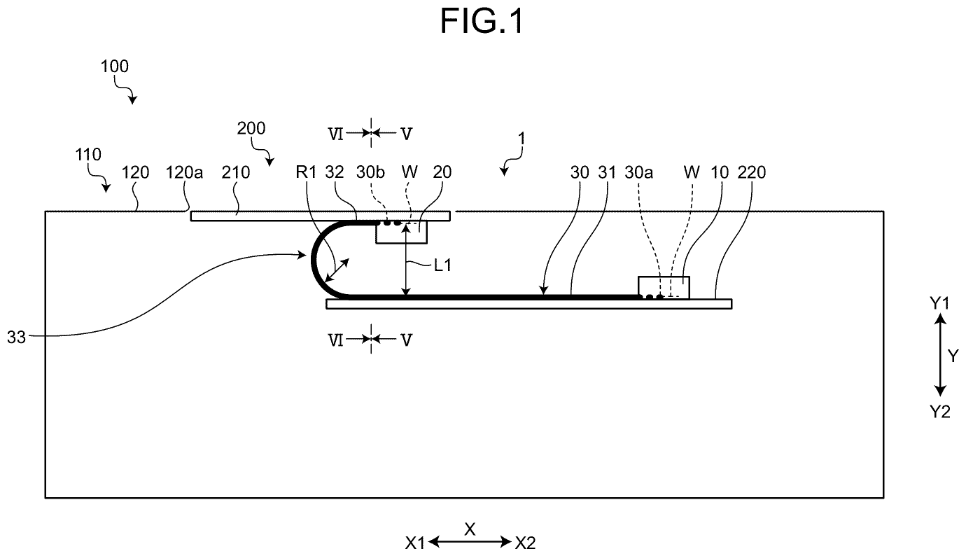

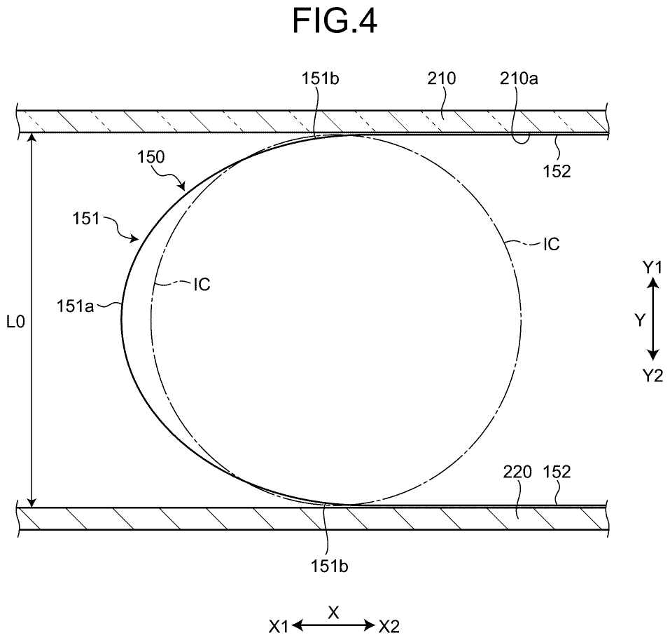

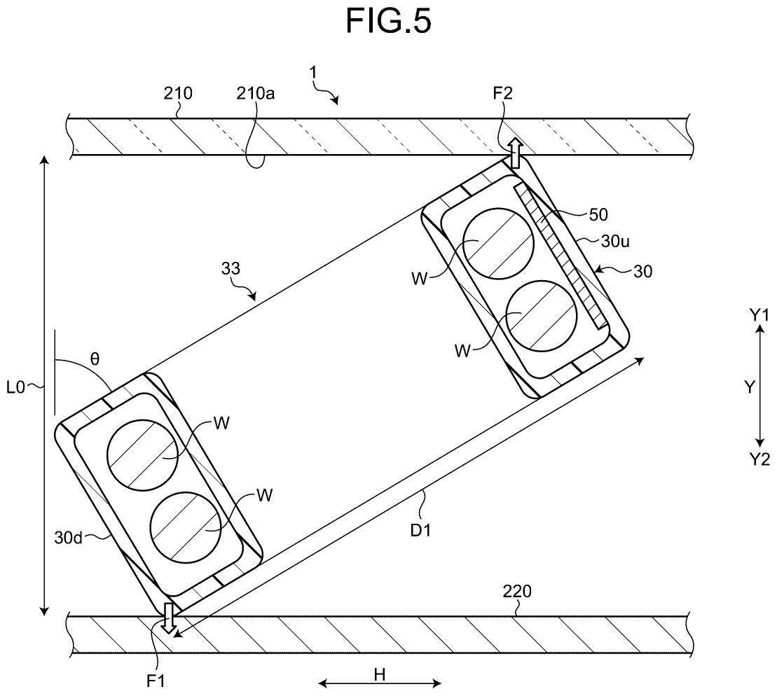

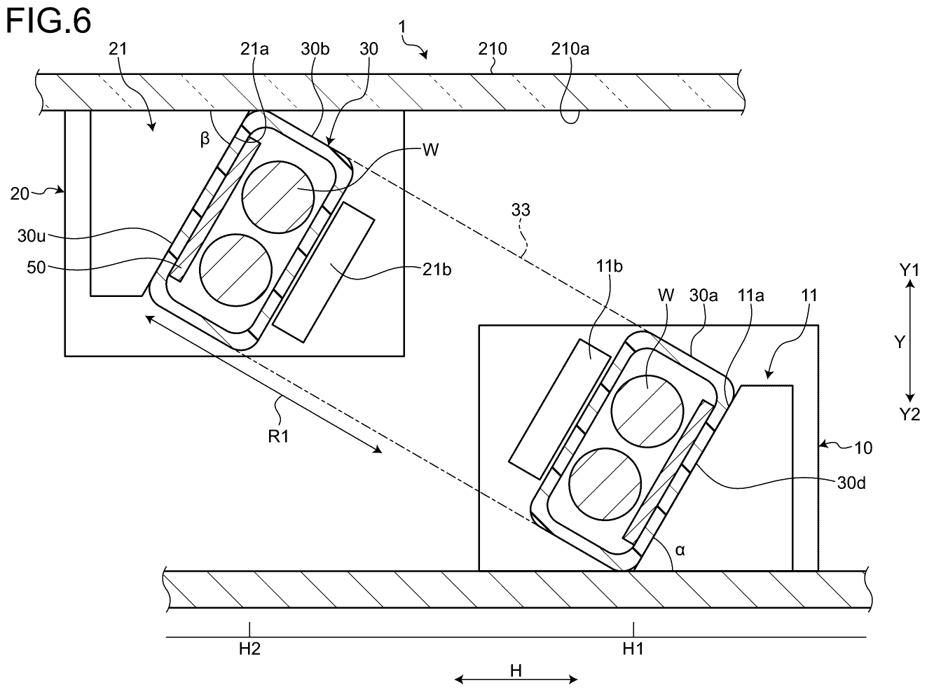

An embodiment will be described with reference to FIGS. 1 to 6. The present embodiment relates to a routing structure. FIGS. 1 to 3 are side views of the routing structure according to the embodiment, FIG. 4 is a view for explaining a tapered shape, and FIGS. 5 and 6 are cross-sectional views of the routing structure according to the embodiment. FIG. 5 illustrates a cross section taken along line V-V in FIG. 1. FIG. 6 illustrates a cross section taken along line VI-VI in FIG. 1.

As illustrated in FIG. 1, a routing structure 1 according to the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 has a roof 120 that covers the vehicle interior. The roof 120 has an opening 120a that is open upward.

The vehicle 100 includes a sunroof 200 that opens and closes the opening 120a. The sunroof 200 has a slide body 210, a rail 220, and a routing structure 1. The slide body 210 is a member that slides along a vehicle front-rear direction X with respect to the opening 120a. The slide body 210 according to the present embodiment is a plate-like member that closes the opening 120a or opens the opening 120a. The slide body 210 may be glass configured to allow light to be transmitted therethrough.

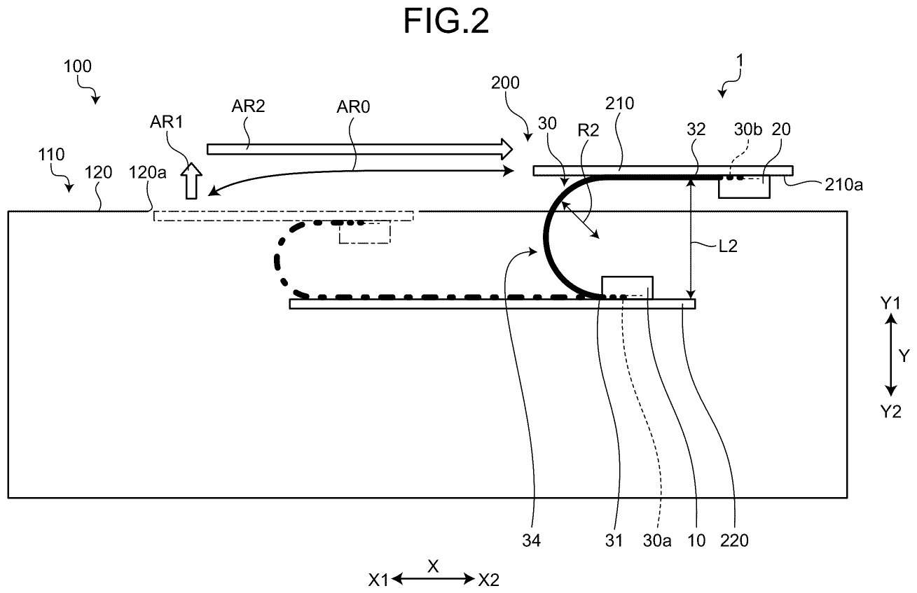

The sunroof 200 includes a mechanism such as a link mechanism that moves the slide body 210 along a predetermined path, and a drive source such as a motor that operates the above mechanism. The sunroof 200 moves the slide body 210 between a fully closed position where the opening 120a is closed and a fully opened position where the opening 120a is opened. FIG. 1 illustrates the slide body 210 at the fully closed position. FIG. 2 illustrates the slide body 210 at the fully opened position.

The rail 220 is fixed to the vehicle body 110. The rail 220 extends in the vehicle front-rear direction X. The rail 220 supports the mechanism for moving the slide body 210, and guides the mechanism in the vehicle front-rear direction X. The rail 220 further supports an exterior member 30, and forms a first extending portion 31 on the exterior member 30.

The sunroof 200 according to the present embodiment moves the slide body 210 along a path AR0 illustrated in FIG. 2. The movement of the slide body 210 along the path AR0 includes a movement along the vehicle front-rear direction X and a movement along a vehicle up-down direction Y. When the slide body 210 moves from the fully closed position toward the fully opened position, the slide body 210 moves toward an upper side Y1 in the vehicle up-down direction Y and moves toward a rear side X2 in the vehicle front-rear direction X as indicated by an arrow AR1 in FIG. 2.

Conversely, when the slide body 210 moves from the fully opened position to the fully closed position, the slide body 210 moves toward a front side X1 in the vehicle front-rear direction X and moves toward a lower side Y2 in the vehicle up-down direction Y.

As illustrated in FIGS. 1 to 3 and 5, the routing structure 1 includes a first fixing part 10, a second fixing part 20, an exterior member 30, an electric wire W, and a biasing member 50. The exterior member 30 and the electric wire W constitute a wire harness routed between the vehicle body 110 and the slide body 210.

The first fixing part 10 is a member fixed to the vehicle body 110 of the vehicle 100. The first fixing part 10 according to the present embodiment is fixed to the rail 220, and supported by the vehicle body 110 via the rail 220. The first fixing part 10 may be a protector that protects the electric wire W. The first fixing part 10 is formed of, for example, an insulating synthetic resin. The first fixing part 10 has a space in which the electric wire W is routed and has a holding structure for holding the exterior member 30.

The second fixing part 20 is a member fixed to the slide body 210 of the sunroof 200. The second fixing part 20 is disposed on the upper side Y1 in the vehicle up-down direction Y with respect to the first fixing part 10. The second fixing part 20 may be a protector that protects the electric wire W. The second fixing part 20 is formed of, for example, an insulating synthetic resin. The second fixing part 20 has a space in which the electric wire W is routed and has a holding structure for holding the exterior member 30.

The exterior member 30 is an elastically deformable tubular member. The exterior member 30 is, for example, a member called a corrugated tube. The exterior member 30 is formed of, for example, an insulating synthetic resin. The exterior member 30 may have a bellows shape.

The exterior member 30 has a first end portion 30a held by the first fixing part 10 and a second end portion 30b held by the second fixing part 20. The first fixing part 10 holds the first end portion 30a such that the exterior member 30 extends from the first fixing part 10 along the rail 220 in the vehicle front-rear direction X.

The first fixing part 10 according to the present embodiment holds the first end portion 30a such that the exterior member 30 extends from the first fixing part 10 toward the front side X1.

The second fixing part 20 holds the second end portion 30b such that the exterior member 30 extends from the second fixing part 20 along the slide body 210 in the vehicle front-rear direction X. The second fixing part 20 according to the present embodiment holds the second end portion 30b such that the exterior member 30 extends from the second fixing part 20 toward the front side X1.

The electric wire W and the biasing member 50 are inserted through the exterior member 30. The electric wire W is, for example, a sheathed electric wire having a stranded wire and a sheath. The electric wire W may be a flat routing material, a printed circuit body, or another circuit body. The electric wire W drawn out from the first end portion 30a is connected to a power supply and a control device disposed in the vehicle body 110. The electric wire W drawn out from the second end portion 30b is connected to a load disposed on the slide body 210. The load disposed on the slide body 210 may be, for example, a lighting device, a light control film disposed on the glass of the slide body 210, or another electric load.

As illustrated in FIGS. 1 and 2, the exterior member 30 has a curved portion 33 or 34 that is curved in the vehicle front-rear direction X between the first end portion 30a and the second end portion 30b. The curved portion 33 or 34 is formed by the biasing member 50. The curved portion 33 illustrated in FIG. 1 is a curved portion formed in the exterior member 30 in a state where the slide body 210 is at the fully closed position. The curved portion 33 has a radius R1. The curved portion 34 illustrated in FIG. 2 is a curved portion formed in the exterior member 30 in a state where the slide body 210 is at the fully opened position. The curved portion 34 has a radius R2. The electric wire W in which the curved portion 33 or 34 is formed has a U shape or a J shape.

As illustrated in FIG. 1, when the slide body 210 is at the fully closed position, a distance of the second end portion 30b from the first end portion 30a in the vehicle up-down direction Y is a first distance L1. The radius R1 of the curved portion 33 has a size corresponding to the first distance L1.

As illustrated in FIG. 2, when the slide body 210 is at the fully opened position, a distance of the second end portion 30b from the first end portion 30a in the vehicle up-down direction Y is a second distance L2. The radius R2 of the curved portion 34 has a size corresponding to the second distance L2.

In the sunroof 200 according to the present embodiment, the second distance L2 at the fully opened position is larger than the first distance L1 at the fully closed position. Accordingly, the radius R1 of the curved portion 33 when the slide body 210 is at the fully closed position is smaller than the radius R2 of the curved portion 34 when the slide body 210 is at the fully opened position. In addition, the radius R1 when the slide body 210 is at the fully closed position is smaller than a radius of a curved shape formed in the biasing member 50 when the slide body 210 is at another position. In other words, the curved shape formed in the biasing member 50 has a smallest radius when the slide body 210 is at the fully closed position.

The second end portion 30b of the exterior member 30 moves together with the slide body 210. At this time, the exterior member 30 follows the movement of the second fixing part 20 while gradually changing the position where the curved shape is formed.

As illustrated in FIG. 5, the biasing member 50 according to the present embodiment is a member that presses the exterior member 30 toward the slide body 210. The biasing member 50 according to the present embodiment is a plate-like member, and is elastically deformable. The biasing member 50 is formed of a metal or a resin.

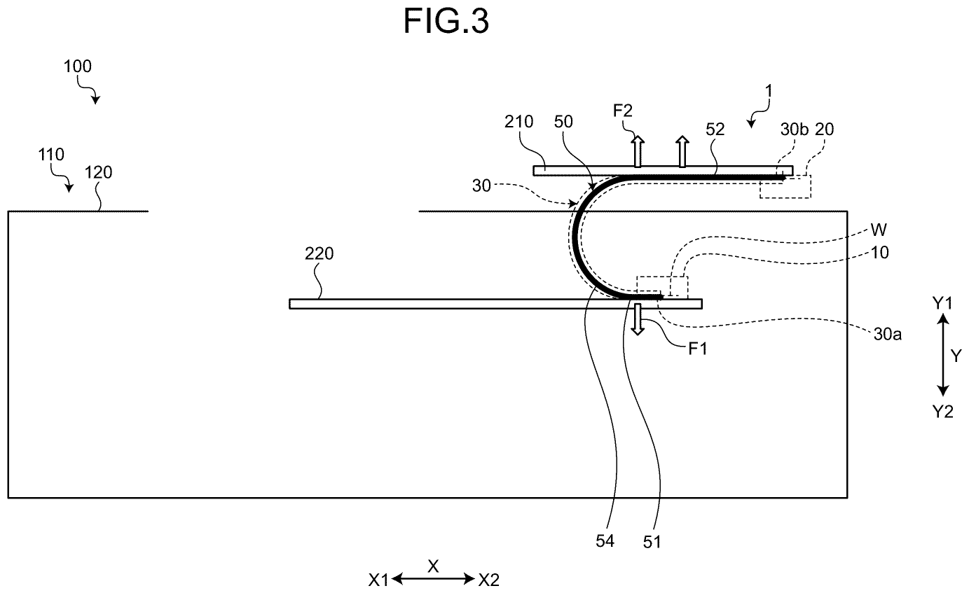

As illustrated in FIG. 3, the exterior member 30, the electric wire W, and the biasing member 50 are routed in a curved state in a U shape or a J shape. That is, the biasing member 50 extends from the first fixing part 10 to the second fixing part 20 with a curved portion 54.

The biasing member 50 bent to have the curved portion 54 forms the curved portion 33 or 34 in the exterior member 30, and applies the pressing force F1 and the pressing force F2 to the exterior member 30. The pressing force F1 is a force in the vehicle up-down direction Y, and presses the exterior member 30 toward the rail 220. The pressing force F2 is a force in the vehicle up-down direction Y, and presses the exterior member 30 toward the slide body 210. The pressing forces F1 and F2 are restoring forces generated in the bent biasing member 50.

The pressing force F1 forms a first extending portion 31 in the exterior member 30. The pressing force F2 forms a second extending portion 32 in the exterior member 30. As illustrated in FIG. 2, etc., the second extending portion 32 is a portion extending along a vehicle interior side surface 210a of the slide body 210. The vehicle interior side surface 210a is a surface facing the lower side Y2. When the vehicle interior side surface 210a is a flat surface, the second extending portion 32 is formed straight. When the vehicle interior side surface 210a has a curved shape, the second extending portion 32 has a curved shape along the vehicle interior side surface 210a.

The biasing member 50 according to the present embodiment is configured to press the exterior member 30 toward the slide body 210 both when the slide body 210 is at the fully closed position and when the slide body 210 is at the fully opened position. In other words, the biasing member 50 has rigidity capable of pressing the exterior member 30 against and in contact with the slide body 210 at all times. Therefore, the routing structure 1 according to the present embodiment can stabilize the shape of the exterior member 30. The biasing member 50 can keep the exterior member 30 in contact with the slide body 210 against an external force such as a vibration generated, for example, during traveling.

Here, the exterior member 30, the electric wire W, and the biasing member 50 are disposed to be curved in a narrow space between the slide body 210 and the rail 220. When the bending radius of the biasing member 50 decreases, a tapered shape may be formed in the biasing member 50 as will be described below.

FIG. 4 illustrates a tapered shape formed in a biasing member 150 according to a comparative example. The biasing member 150 according to the comparative example has a plate shape similar to that of the biasing member 50 according to the embodiment. The biasing member 150 has a curved portion 151 and straight portions 152. The straight portions 152 are portions extending straight, and are formed along the slide body 210 and the rail 220, respectively.

The curved portion 151 has a leading end portion 151a and two tail end portions 151b. The leading end portion 151a is a central portion of the curved portion 151, and has a convex shape in the vehicle front-rear direction X. The tail end portions 151b are end portions of the curved portion 151 in the vehicle up-down direction Y, and are portions connected to the straight portions 152. The curved portion 151 has a tapered shape. More specifically, the shape of the curved portion 151 is a shape in which the bending radius decreases from the tail end portion 151b toward the leading end portion 151a.

A virtual circle IC is illustrated in FIG. 4. The virtual circle IC is a circle whose diameter is a distance L0 in the vehicle up-down direction Y from the rail 220 to the slide body 210. The bending radius of the leading end portion 151a is smaller than the radius of the virtual circle IC. In the curved portion 151 having a tapered shape, the leading end portion 151a has a smaller bending radius than the tail end portion 151b. When the distance L0 from the rail 220 to the slide body 210 is small, such a tapered shape is easily formed in the curved portion 151.

As will be described below, the routing structure 1 according to the present embodiment is configured to secure an appropriate bending radius even in a narrow space and suppress the biasing member 50 from having a tapered shape.

FIG. 5 illustrates cross sections of the exterior member 30, the electric wire W, and the biasing member 50 when viewed in the vehicle front-rear direction X. As illustrated in FIG. 5, the exterior member 30 according to the present embodiment has a rectangular cross-sectional shape. The exemplified shape of the biasing member 50 is a substantially flat plate shape. The exemplified biasing member 50 is disposed outside the electric wire W inside the exterior member 30. That is, the biasing member 50 is positioned outside the electric wire W in the radial direction in the curved portion 33 or 34.

As illustrated in FIG. 5, in the routing structure 1 according to the present embodiment, the exterior member 30 is held such that the curved portion 33 is inclined with respect to the vehicle up-down direction Y when viewed from the vehicle front-rear direction X. An inclination angle θ [deg] of the curved portion 33 with respect to the vehicle up-down direction Y is determined, for example, to increase the radius R1 of the curved portion 33 as compared with that in a case where the curved portion 33 is not inclined. The inclination angle θ of the curved portion 33 is set, for example, based on the width of the exterior member 30 and the width of the biasing member 50. The width of the exterior member 30 and the width of the biasing member 50 may be determined so as to realize a desired inclination angle θ.

For example, the inclination angle θ is set such that an outer diameter D1 of the curved portion 33 is greater than the distance L0 from the rail 220 to the slide body 210. The outer diameter D1 is a distance from an upper surface 30u of the exterior member 30 to a lower surface 30d of the exterior member 30. The upper surface 30u is an outer surface of the exterior member 30, and faces the vehicle interior side surface 210a of the slide body 210. An end portion of the upper surface 30u comes into contact with the vehicle interior side surface 210a, and is pressed toward the vehicle interior side surface 210a. The lower surface 30d is an outer surface of the exterior member 30, and faces the rail 220. The upper surface 30u and the lower surface 30d face each other in opposite directions. An end portion of the lower surface 30d comes into contact with the rail 220, and is pressed toward the rail 220.

As illustrated in FIG. 6, the first fixing part 10 and the second fixing part 20 hold the first end portion 30a and the second end portion 30b to incline the curved portion 33 with respect to the vehicle up-down direction Y when viewed from the vehicle front-rear direction X.

The first fixing part 10 includes a holding part 11 that holds the first end portion 30a of the exterior member 30. The holding part 11 has a first support surface 11a and a clamping portion 11b. The first support surface 11a supports the lower surface 30d of the exterior member 30. The first support surface 11a is an inclined surface inclined with respect to the vehicle up-down direction Y. An inclination angle α [deg] of the first support surface 11a with respect to a vehicle width direction H is, for example, the same as the inclination angle θ of the curved portion 33.

The holding part 11 holds the first end portion 30a by sandwiching the first end portion 30a between the first support surface 11a and the clamping portion 11b. The holding part 11 locks, for example, a bellows-shaped groove portion of the exterior member 30. The structure for holding the first end portion 30a is not limited to the first support surface 11a and the clamping portion 11b. For example, the first end portion 30a may be fixed to the first support surface 11a by a binding band, a tape, or the like.

The second fixing part 20 includes a holding part 21 that holds the second end portion 30b of the exterior member 30. The holding part 21 has a second support surface 21a and a clamping portion 21b. The second support surface 21a supports the upper surface 30u of the exterior member 30. The second support surface 21a is an inclined surface inclined with respect to the vehicle up-down direction Y. An inclination angle β [deg] of the second support surface 21a with respect to the vehicle width direction H is, for example, the same as the inclination angle θ of the curved portion 33.

The holding part 21 holds the second end portion 30b by sandwiching the second end portion 30b between the second support surface 21a and the clamping portion 21b. The holding part 21 locks, for example, a bellows-shaped groove portion of the exterior member 30. The structure for holding the second end portion 30b is not limited to the second support surface 21a and the clamping portion 21b. For example, the second end portion 30b may be fixed to the second support surface 21a by a binding band, a tape, or the like.

When viewed from the vehicle front-rear direction X, the first support surface 11a of the first fixing part 10 and the second support surface 21a of the second fixing part 20 face each other. That is, the holding part 11 and the holding part 21 are arranged to hold the exterior member 30 such that the first end portion 30a and the second end portion 30b face each other when viewed from the vehicle front-rear direction X.

The first fixing part 10 holds the first end portion 30a of the exterior member 30 at a first position H1 in the vehicle width direction H. The second fixing part 20 holds the second end portion 30b of the exterior member 30 at a second position H2 in the vehicle width direction H. The first position H1 is, for example, a position of a corner of the first end portion 30a contacting the rail 220. The second position H2 is, for example, a position of a corner of the second end portion 30b contacting the slide body 210. In the vehicle width direction H, the second position H2 is a position different from the first position H1.

In the routing structure 1 according to the present embodiment, the curved portion 33 is inclined with respect to the vehicle up-down direction Y. Therefore, it is possible to increase the radius R1 of the curved portion 33 as compared with that in a configuration in which the curved portion 33 is not inclined with respect to the vehicle up-down direction Y. Therefore, the routing structure 1 according to the present embodiment can suppress the biasing member 50 from having a tapered shape in the curved portion 33.

Since the exterior member 30 is held in an inclined manner as described above, the curved portion 34 is also inclined with respect to the vehicle up-down direction Y in the fully opened state. Since the curved portion 34 is inclined with respect to the vehicle up-down direction Y, the biasing member 50 is suppressed from having a tapered shape in the curved portion 34. In addition, as the radius R1 or R2 of the curved portion 33 or 34 increase, the bending radius of the electric wire W also increases. As a result, the routing structure 1 according to the present embodiment can improve the durability of the electric wire W.

As described above, the routing structure 1 according to the present embodiment includes a first fixing part 10, a second fixing part 20, an exterior member 30, an electric wire W, and a biasing member 50. The first fixing part 10 is fixed to a vehicle body 110 of a vehicle 100. The second fixing part 20 is fixed to a slide body 210. The slide body 210 moves along a vehicle front-rear direction X with respect to an opening 120a provided in a roof 120 of the vehicle body 110. The exterior member 30 has a first end portion 30a held by the first fixing part 10 and a second end portion 30b held by the second fixing part 20. The electric wire W and the biasing member 50 are inserted through the exterior member 30.

The biasing member 50 forms a curved portion 33 or 34 curved in the vehicle front-rear direction X between the first end portion 30a and the second end portion 30b of the exterior member 30. The second fixing part 20 is disposed on the upper side Y1 in the vehicle up-down direction Y with respect to the first fixing part 10. The first fixing part 10 and the second fixing part 20 hold the first end portion 30a and the second end portion 30b to incline the curved portion 33 or 34 with respect to the vehicle up-down direction Y when viewed from the vehicle front-rear direction X. The routing structure 1 according to the present embodiment can the biasing member 50 from having a tapered shape in the curved portion 33 or 34 by inclining the curved portion 33 or 34.

In the present embodiment, an inclination angle θ of the curved portion 33 with respect to the vehicle up-down direction Y is an angle that increases a radius R1 of the curved portion 33 as compared with that in a case where the curved portion 33 is not inclined. Therefore, the biasing member 50 can be suppressed from having a tapered shape at least in the curved portion 33.

An inclination angle of the curved portion 34 with respect to the vehicle up-down direction Y may be set to an angle that increases a radius R2 of the curved portion 34 as compared with that in a case where the curved portion 34 is not inclined. In this case, the biasing member 50 can be suppressed from having a tapered shape in the curved portion 34.

In the present embodiment, the first fixing part 10 holds the first end portion 30a at a first position H1 in a vehicle width direction H. The second fixing part 20 holds the second end portion 30b at a second position H2 in the vehicle width direction H. The second position H2 is a position different from the first position H1. Since the first end portion 30a and the second end portion 30b are held at different positions in the vehicle width direction H, the inclination of the curved portion 33 or 34 is realized.

The first fixing part 10 according to the present embodiment has a first support surface 11a inclined with respect to the vehicle up-down direction Y, and supports the first end portion 30a by the first support surface 11a. The second fixing part 20 has a second support surface 21a inclined with respect to the vehicle up-down direction Y, and supports the second end portion 30b by the second support surface 21a. Since the first end portion 30a and the second end portion 30b are supported by the inclined first support surface 11a and second support surface 21a, the inclined posture of the curved portion 33 or 34 is stabilized.

In the present embodiment, the first fixing part 10 and the second fixing part 20 are disposed such that the first support surface 11a and the second support surface 21a face each other when viewed in the vehicle front-rear direction X. With such an arrangement, the biasing member 50 is hardly twisted.

The biasing member 50 is not limited to a plate-like member. The biasing member 50 may be, for example, a rod-like member having a circular cross-sectional shape. The biasing member 50 may be a rod-like member having a polygonal cross-sectional shape. The exterior member 30 is not limited to a so-called corrugated tube. The exterior member 30 may be a braided tube or another member used as an exterior member. The biasing member 50 may be disposed inside the electric wire W. That is, the biasing member 50 may be disposed inside the electric wire W in the radial direction in the curved portion 33 or 34.

The embodiments disclosed above can be carried out in an appropriate combination.

In the routing structure according to the present embodiment, the first fixing part and the second fixing part hold the first end portion and the second end portion of the exterior member to incline the curved portion with respect to the vehicle up-down direction when viewed from the vehicle front-rear direction. The routing structure according to the present embodiment is capable of suppressing the biasing member from having a tapered shape by increasing the diameter of the curved portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixing part fixed to a vehicle body of a vehicle;
a second fixing part fixed to a slide body that moves along a vehicle front-rear direction with respect to an opening provided in a roof of the vehicle body;
an exterior member having a first end portion held by the first fixing part and a second end portion held by the second fixing part;
an electric wire inserted through the exterior member; and
a biasing member inserted through the exterior member and forming a curved portion curved in the vehicle front-rear direction between the first end portion and the second end portion of the exterior member, wherein
the second fixing part is disposed above the first fixing part in a vehicle up-down direction, and
the first fixing part and the second fixing part hold the first end portion and the second end portion such that the curved portion is inclined with respect to the vehicle up-down direction when viewed from the vehicle front-rear direction.

2. The routing structure according to claim 1, wherein
an inclination angle of the curved portion with respect to the vehicle up-down direction is an angle that increases a radius of the curved portion as compared with that in a case where the curved portion is not inclined.

3. The routing structure according to claim 1, wherein
the first fixing part holds the first end portion at a first position in a vehicle width direction, and
the second fixing part holds the second end portion at a second position different from the first position in the vehicle width direction.

4. The routing structure according to claim 1, wherein
the first fixing part has a first support surface inclined with respect to the vehicle up-down direction, and supports the first end portion by the first support surface, and
the second fixing part has a second support surface inclined with respect to the vehicle up-down direction, and supports the second end portion by the second support surface.

5. The routing structure according to claim 4, wherein
the first fixing part and the second fixing part are disposed such that the first support surface and the second support surface face each other when viewed from the vehicle front-rear direction.
